(19) United States
(12) Patent Application Publication
(10) Pub. No.: US 2019/0018371 A1
(43) Pub. Date: Jan. 17, 2019

(54) CLEANING MACHINE AND BASKET FOR TIMEPIECE OR JEWELLERY COMPONENTS

(71) Applicant: Montres Breguet S.A., L'Abbaye (CH)

(72) Inventors: Amandine RUCHAT, Le Brassus (CH); Andreas STEINER, Le Solliat (CH); Benoit SAUTY, Morges (CH)

(73) Assignee: Montres Breguet S.A., L'Abbaye (CH)

(21) Appl. No.: 16/012,800

(22) Filed: Jun. 20, 2018

(30) Foreign Application Priority Data
Jul. 11, 2017 (EP) 17180789.4

(51) Int. Cl. G04D 3/08; B08B 11/02; B08B 3/10

(52) U.S. Cl. CPC G04D 3/086; B08B 3/10; B08B 11/02

(57) ABSTRACT

Cleaning machine for timepiece or jewellery components, including cleaning baskets with a receptacle including a bottom and a peripheral partition separating the internal volume of the receptacle, and an environment outside the basket, which includes in the bottom or in the peripheral partition, flared holes whose cross-section is smaller towards the receptacle than towards the external environment, the machine including cleaning means and drying means arranged to circulate cleaning or drying fluids through flow orifices and flared holes, and effluent collecting means arranged to collect effluents from the cleaning and drying operations.

This application claims priority from European Patent Application No. 17180789.4 filed on Jul. 11, 2017; the entire disclosure of which is incorporated herein by reference

### FIELD OF THE INVENTION

The invention concerns a cleaning basket for timepiece or jewellery components, comprising a receptacle arranged for receiving components, the receptacle comprising at least a bottom arranged to act as support surface for components, and at least one peripheral partition arranged to retain the components inside the receptacle and defining a separation between the internal volume of the receptacle, and an environment outside the cleaning basket, this basket having a plurality of flow orifices arranged to allow the flow of cleaning and/or drying fluids through the bottom and/or through said at least one peripheral partition.

The invention also concerns a cleaning machine for timepiece or jewellery components, comprising such baskets.

The invention concerns the field of cleaning and drying timepieces and pieces of jewellery.

### BACKGROUND OF THE INVENTION

The cleaning of timepiece components or the like is an important operation, which affects the performance and lifetime of the end product, and thus the manufacturer's reputation. The components are placed, for this operation, in cleaning baskets. Two types of baskets are the most common: steel baskets (especially stainless steel or galvanised steel), and plastic baskets.

Steel baskets are highly efficient in cleaning machines with an integrated drying system, but they have the drawback of deteriorating the components, particularly following shocks.

Plastic baskets do not damage the components, but they do not allow for optimum drying, because of residual moisture on the components at the end of the drying cycle.

The specific context of timepiece and jewellery components is characterized by the very small dimensions of the components to be cleaned, which results in the need to use baskets with holes of suitable diameter to avoid any components being lost or stuck in a hole, these very small diameters do not allow for good fluid flow, or good evacuation of residues.

### SUMMARY OF THE INVENTION

The invention proposes to develop baskets that allow for optimum drying, with the least possible deterioration of the components.

The principle is to optimise the geometry of the holes and the geometry of the divider partitions of the plastic baskets, which have the essential advantage of not damaging the cleaned and dried components.

To this end, the invention concerns a cleaning basket according to claim 1.

The invention also concerns a cleaning machine according to claim 15.

### BRIEF DESCRIPTION OF THE DRAWINGS

Other features and advantages of the invention will appear upon reading the following detailed description, with reference to the annexed drawings, in which:

FIG. 1 shows a schematic and perspective view of a cleaning basket according to the invention, including, in a non-limiting manner:
a substantially cylindrical main body having a bottom and a peripheral partition together defining a receptacle for components, and a hub and slots for attaching intermediate partitions;
an intermediate ring placed on the bottom of the main body and comprising notches for securing intermediate partitions;
a set of radial intermediate partitions arranged to be secured in the notches of the hub, the peripheral slots, and comprising complementary notches to those of the intermediate ring;
   and wherein the bottom and the peripheral partition include a plurality of flow orifices which are flared holes whose cross-section is smaller towards the receptacle than towards the environment outside the cleaning basket.

FIG. 2 represents, in a similar manner to FIG. 1, an exploded view of the same cleaning basket.

FIGS. 3 and 4 are local cross-sections of different partitions of the basket, including such outwardly flared holes.

FIG. 5 is a block diagram showing a cleaning machine according to the invention.

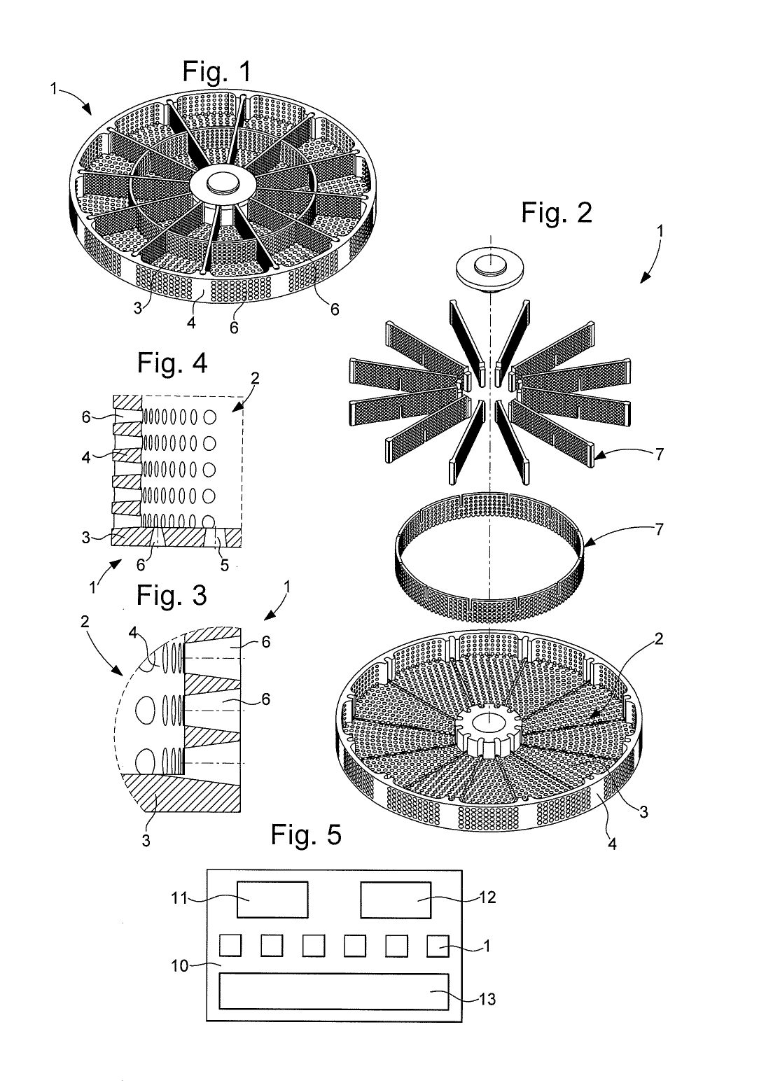

### DETAILED DESCRIPTION OF PREFERRED EMBODIMENTS

The invention concerns a cleaning basket 1 for timepiece or jewellery components comprising a receptacle 2 arranged for receiving components. This receptacle 2 includes at least a bottom 3, which is arranged to serve as support surface for components, and at least one peripheral partition 4, which is arranged to retain the components inside receptacle 2, and which defines a separation between the internal volume of receptacle 2, and the environment outside cleaning basket 1.

Basket 1 includes a plurality of flow orifices arranged to allow the flow of cleaning and/or drying fluids through bottom 3 and/or through said at least one peripheral partition 4.

According to the invention, cleaning basket 1 includes, in bottom 3 and/or in the at least one peripheral partition 4, a plurality of such flow orifices 5, which are flared holes 6, whose cross-section is smaller towards receptacle 2 than towards the external environment.

More particularly, cleaning basket 1 includes a plurality of flared holes 6, both in bottom 3 and in the at least one peripheral partition 4.

More particularly, cleaning basket 1 is a nested assembly comprising an outer basket 1 arranged to contain at least one other removable inner basket 1, and this outer basket and every inner basket each include a plurality of such flared holes 6 whose cross-section is smaller towards receptacle 2 of the basket concerned than towards the environment outside the basket concerned.

More particularly, cleaning basket 1 is an assembly comprising at least one divider partition 7, as the intermediate ring or the radial divider partitions of the Figures, to separate the components during cleaning and/or drying operations. And each such divider partition 7 includes a plurality of such flared holes 6.

More particularly still, at least one divider partition 7 is arranged to define a primary internal volume and a primary external volume, which faces the environment outside basket 1, and which also includes a plurality of flared holes 6 whose cross-section is smaller towards the primary internal volume than towards the primary external volume.

In another embodiment not illustrated by the Figures, at least one divider partition 7 includes a network of flared holes 6, flaring alternately towards a first side or a second side, opposite to the first side, of this divider partition 7.

More particularly, every partition comprised in cleaning basket 1, and which is arranged to be in contact with a component, includes a plurality of flared holes 6.

More particularly, cleaning basket 1 is made of plastic material. More particularly, the plastic material is POM.

Advantageously and economically, at least some of flared holes 6 are conical holes. More particularly, all the flared holes 6 are conical holes.

More particularly, the conical hole has a total opening angle at the apex comprised between 1° and 45°, and a smaller diameter comprised between 0.5 mm and 1.0 mm.

More particularly, the conical orifice has a larger diameter comprised between 0.5 mm and 2.5 mm.

More particularly, each partition of basket 1 which has flared holes 6 has a thickness comprised between 0.5 mm and 1.5 mm.

More particularly, flared holes 6 are grouped together locally into sieves, wherein the smallest section between two immediately adjacent flared holes 6 is comprised between 0.5 mm and 1.5 mm.

By means of these flared holes, the invention optimises the evacuation of moisture inside the baskets, and thus ensures that dry components are obtained with no residues, at the end of a cleaning cycle with an integrated drying system.

The invention also concerns a cleaning machine 10 for timepiece or jewellery components comprising such cleaning baskets 1, machine 10 including cleaning means 11 and drying means 12 arranged to circulate cleaning or drying fluids through flow orifices 5 and flared holes 6, and effluent collecting means 13 arranged to collect effluents from the cleaning and drying operations.

What is claimed is:

1. A cleaning basket for timepiece or jewellery components comprising a receptacle arranged for receiving components, said receptacle including at least a bottom, which is arranged to serve as support surface for said components, and at least one peripheral partition, arranged to retain said components inside said receptacle and defining a separation between the internal volume of said receptacle, and an environment outside said cleaning basket, said basket including a plurality of flow orifices arranged to allow the flow of cleaning and/or drying fluids through said bottom and/or said at least one peripheral partition, wherein said cleaning basket includes, in said bottom and/or in said at least one peripheral partition, a plurality of said flow orifices, which are flared holes, whose cross-section is smaller towards said receptacle than towards said external environment.

2. The cleaning basket according to claim 1, wherein said cleaning basket includes a plurality of said flared holes both in said bottom and in said at least one peripheral partition.

3. The cleaning basket according to claim 1, wherein said cleaning basket is a nested assembly comprising an outer basket arranged to contain at least one other removable inner basket, and wherein said outer basket and every inner basket each include a plurality of said flared holes whose cross-section is smaller towards the receptacle of the basket concerned than towards the environment outside the basket concerned.

4. The cleaning basket according to claim 1, wherein said cleaning basket is an assembly comprising at least one divider partition for separating said components during cleaning and/or drying operations, and wherein each said divider partition includes a plurality of said flared holes.

5. The cleaning basket according to claim 4, wherein at least one said divider partition 7 is arranged to define a primary internal volume and a primary external volume, which faces the environment outside said basket, and includes a plurality of said flared holes whose cross-section is smaller towards said primary internal volume than towards said primary external volume.

6. The cleaning basket according to claim 4, wherein at least one said divider partition includes a network of said flared holes, flaring alternately towards a first side or a second side, opposite to said first side, of said divider partition.

7. The cleaning basket according to claim 1, wherein every partition comprised in said cleaning basket, and which is arranged to be in contact with a said component, includes a plurality of said flared holes.

8. The cleaning basket according to claim 1, wherein said cleaning basket is made of plastic material.

9. The cleaning basket according to claim 8, wherein said plastic material is POM.

10. The cleaning basket according to claim 1, wherein at least some of said flared holes are conical holes.

11. The cleaning basket according to claim 10, wherein said conical hole has a total opening angle at the apex comprised between 1° and 45°, and a smaller diameter comprised between 0.5 mm and 1.0 mm.

12. The cleaning basket according to claim 11, wherein said conical hole has a larger diameter comprised between 0.5 mm and 2.5 mm.

13. The cleaning basket according to claim 1, wherein each partition of said basket which includes said flared holes has a thickness comprised between 0.5 mm and 1.5 mm.

14. The cleaning basket according to claim 1, wherein the said flared holes are grouped together locally into sieves, wherein the smallest section between two immediately adjacent said flared holes is comprised between 0.5 mm and 1.5 mm.

15. A cleaning machine for timepiece or jewellery components, including cleaning baskets according to claim 1, said machine including cleaning means and drying means arranged to circulate cleaning or drying fluids through said flow orifices and said flared holes, and effluent collecting means arranged to collect the effluents from the cleaning and drying operations.
